(19) United States
(12) Patent Application Publication
(10) Pub. No.: US 2010/0149575 A1
(43) Pub. Date: Jun. 17, 2010

(54) IMAGE DISPLAYING SYSTEM, IMAGE FORMING APPARATUS, JOB EXECUTION CONTROL METHOD, AND RECORDING MEDIUM

(75) Inventors: Kaitaku Ozawa, Itami-shi (JP); Kei Shigehisa, Amagasaki-shi (JP); Takeshi Morikawa, Takarazuka-shi (JP); Toshimichi Iwai, Kitakatsuragi-gun (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/630,045

(22) Filed: Dec. 3, 2009

(30) Foreign Application Priority Data
Dec. 11, 2008 (JP) 2008-315960

(51) Int. Cl. G06F 3/12

(52) U.S. Cl. 358/1.13; 358/1.15

(57) ABSTRACT

An image displaying system has a projector, an MFP and a client terminal device that are connected to one another via a LAN. In a setting screen of a printer driver installed in the client terminal device, a print job or a projection job is selected, and an image file for execution of the selected job is specified, and job data having header information and image data of the specified image file is generated and transmitted to the MFP. When the received job is an image displaying job, the MFP transmits image data pertaining to the image displaying job to the projector for displaying an image. Accordingly, convenience of the MFP having the projector connected thereto is enhanced.

This application is based on application No. 2008-315960 filed in Japan, the content of which is hereby incorporated by reference.

### BACKGROUND OF THE INVENTION

(1) Field of the Invention

The present invention relates to an image displaying system in which an image can be displayed by transferring image data from an image forming apparatus to an image displaying device, an image forming apparatus used in the image displaying system, a job execution control method executed by the image forming apparatus, and a recording medium recording thereon a job execution control program or a printer driver.

(2) Description of the Related Art

With regard to digital image forming apparatuses, users have diverse needs. This applies particularly to Multi Function Peripherals (hereinafter, simply referred to as “MFP”) with a plurality of functions, such as a copy function, a print function, and a scan function. In recent years, a proposal has been made for transferring an image read by a scanner to a liquid-crystal type projector and the like in order to display the image on a large screen (e.g. Japanese Unexamined Patent Application Publication No. 2003-348269).

With the stated configuration, since a projector can promptly display a scanned image, for example, at a meeting with many attendees, or a presentation for clients, a user can smoothly conduct the meeting, or make products appeal to the clients effectively.

However, according to the above-mentioned conventional technique, the operator needs to go to the MFP to operate a projector for projecting a desired image. Furthermore, the MFP is the only resource for image data used for displaying an image, which causes great inconvenience to the operator.

### SUMMARY OF THE INVENTION

The present invention is conceived in view of the above problem. The object of the present invention is to provide a user-friendly image displaying system, an image forming apparatus used in the image displaying system, and a recording medium recording thereon a program or a printer driver to be installed in a terminal connected to the image forming apparatus.

To achieve the above object, an image displaying system in accordance with one aspect of the present invention including a terminal device, an image forming apparatus and an image displaying apparatus, the terminal device comprising: a job issuer operable to issue at least one of an image forming job and an image displaying job to the image forming apparatus, and the image forming apparatus comprising: a job receiver operable to receive a job issued by the terminal device; an analyzer operable to conduct an analysis of the job received by the job receiver; an image forming unit operable, when the analysis shows that the received job is an image forming job, to form an image according to image data pertaining to the image forming job; and an image data transferrer operable, when the analysis shows that the received job is an image displaying job, to transfer image data pertaining to the image displaying job to the image displaying apparatus, wherein the image displaying apparatus displays an image according to the image data transferred from the image forming apparatus.

With the stated configuration, a user can specify image data with the terminal device, and the image forming job and/or the image displaying job can be issued to the image forming apparatus. When the received job is an image displaying job, the image forming apparatus can transfer the image data pertaining to the image displaying job to the image displaying device in order to display an image based on the image data. Therefore, the user does not need to be bothered to go and operate the image forming apparatus in order to have the image displaying device display the image. In addition, the image based on the image data stored in the terminal device can be easily displayed using the conventional system where the image displaying device displays an image based on output from the image forming apparatus, which increases the convenience.

An image forming apparatus in accordance with another aspect of the present invention being connectable to a terminal device and an image displaying apparatus, the image forming apparatus comprising: a job receiver operable to receive a job issued by the terminal device; an analyzer operable to conduct an analysis of the job received by the job receiver; an image forming unit operable, when the analysis shows that the received job is an image forming job, to form an image according to image data pertaining to the image forming job; and an image data transferrer operable, when the analysis shows that the received job is an image displaying job, to transfer image data pertaining to the image displaying job to the image displaying apparatus.

A job execution control, method in accordance with yet another aspect of the present invention being executed by an image forming apparatus that is connectable to a terminal device and an image displaying apparatus and that includes an image forming unit and an image data transferrer, the job execution control method comprising the steps of: receiving a job issued by the terminal device; analyzing the job received by the job receiver; forming, when the analysis shows that the received job is an image forming job, an image according to image data pertaining to the image forming job; and transferring, when the analysis shows that the received job is an image displaying job, image data pertaining to the image displaying job to the image displaying apparatus.

A computer readable recording medium in accordance with yet another aspect of the present invention recording thereon a job execution control program executed by an image forming apparatus that is connectable to a terminal device and an image displaying apparatus and that includes an image forming unit and an image data transferrer, the job execution control program causing a computer in the image forming apparatus to execute the steps of: receiving a job issued by the terminal device; analyzing the job received by the job receiver; forming, when the analysis shows that the received job is an image forming job, an image according to image data pertaining to the image forming job; and transferring, when the analysis shows that the received job is an image displaying job, image data pertaining to the image displaying job to the image displaying apparatus.

A computer readable recording medium in accordance with yet another aspect of the present invention recording thereon a printer driver executed by a terminal device included in an image displaying system, the system including the terminal device, an image forming apparatus and at least one image displaying apparatus, the printer driver causes a computer in the terminal device to execute: a first receiving process of receiving at least one of specification of an image forming job, and specification of an image displaying job; a second receiving process of receiving specification of image data used for display when the image displaying job is specified; a third receiving process of receiving specification of an image displaying apparatus that displays an image according to the specified image data; and a transmitting process of transmitting, to the image forming apparatus, the specified image data to which control 25, information is added, the control information including information for identifying the specified image displaying apparatus and an instruction to display an image according to the specified image data.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings;

FIG. 1 shows an example of a configuration of an image displaying system including an MFP pertaining to an embodiment of the present invention;

FIG. 2 is a block diagram showing a configuration of the MFP;

FIG. 3 is a block diagram showing a configuration of a client terminal device;

FIG. 4 is a flow chart showing the details of a job issuing process executed by a CPU of the client terminal device;

FIG. 5 shows a job setting screen that is displayed on a monitor upon activation of a printer driver of the client terminal device;

FIG. 6 shows a projection job setting screen that is displayed when a projection job is selected in FIG. 5;

FIG. 7 is a flow chart showing the details of a job execution process executed by the MFP;

FIG. 8 shows a job history table for registering a history of a job executed by the MFP;

FIG. 9 is a flow chart showing the details or a job re-execution process executed by a controller of the MFP;

FIG. 10 shows a job history list that is displayed on an operation panel of the MFP in the job re-execution process;

FIG. 11 is a flow chart showing the details of a job register process executed by the controller of the MFP;

FIGS. 12A and 12B each show an example of a received job management table for registering received jobs;

FIG. 13 is a flow chart showing the details of a projection job execution process executed by the controller of the MFP in accordance with a modification of the present invention;

FIG. 14 shows a projection job setting screen that is displayed on the monitor of the client terminal device in accordance with the modification;

FIG. 15 shows a projection job setting screen that is displayed on the monitor of the client terminal device in accordance with another modification;

FIG. 16A shows a projection job setting screen that is displayed on the monitor of the client terminal device in accordance with yet another modification; and FIG. 16B shows a window showing a list of searched projectors;

FIG. 17 is a flow chart showing the details of a projector search process executed by the CPU of the client terminal device in a modification shown in FIG. 16;

FIG. 18 shows a projector management table storing therein projectors on a searched network each in correspondence with a projector name and an IP address thereof;

FIG. 19 shows when information with regard to projectors registered in the MFP is shown on a pull-down menu on the projection job setting screen of the client terminal device;

FIG. 20 is a flow chart showing the details of a projector information obtain process executed by the CPU of the client terminal device in a modification shown in FIG. 19;

FIG. 21 is a flowchart showing yet another modification of the projection job execution process executed by the CPU of the MFP;

FIG. 22 shows a projection job setting screen that is displayed on the monitor of the client terminal device in accordance with a modification where a print job and a projection job are simultaneously issued;

FIG. 23 shows a projection job setting screen that is displayed on the monitor of the client terminal device in accordance with a modification where a single projection job can project images of a plurality of image files;

FIG. 24 is a flow chart showing the details of a projection job execution process executed by the CPU of the MFP in the modification shown in FIG. 23; and

FIG. 25 is a flow chart showing the details of a projection job execution process executed by the CPU of the MFP when the projector is turned OFF or in an error status.

### DESCRIPTION OF THE PREFERRED EMBODIMENT

The following describes an embodiment of an image displaying system pertaining to the present invention, using the structure where a client terminal device, an MFP, and a projector are connected with one another via a network, as an example.

(1) Configuration of Image Processing System

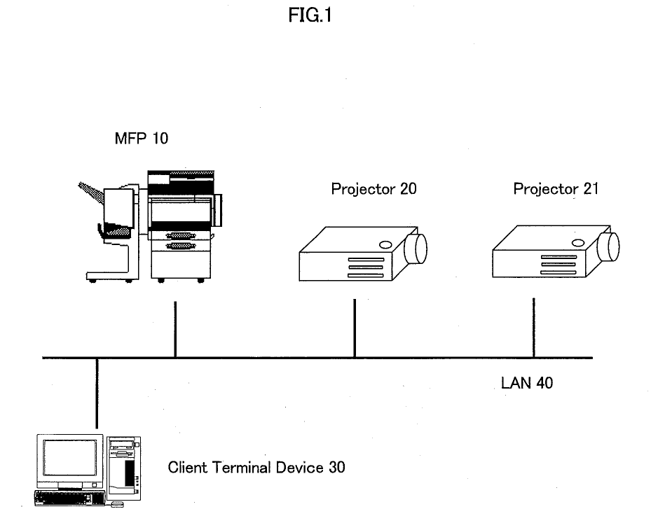

FIG. 1 shows an example of a configuration of an image displaying system pertaining to the embodiment of the present invention.

As shown in FIG. 1, the image displaying system includes an MFP 10, projectors 20 and 21, and a client terminal device 30 that are connected to a LAN (Local Area Network) 40.

The MFP 10, the projectors 20 and 21, and the client terminal device 30 can mutually receive and transmit data using known network communication protocols.

The MFP 10 can execute a copy job or a print job. Also, the MFP 10 can transmit image data to the projector 20 or 21 when receiving an instruction from the client terminal device 30, and execute a job for projecting an image on an unillustrated screen (hereinafter, referred to as “projection job”).

The projectors 20 and 21 are each, for instance, a liquid crystal projector connectable to a network. When receiving RGB image data and audio data from the MFP 10, the projectors 20 and 21 has an image displayed on a transmissive color liquid crystal panel, projects lamp light having transmitted the panel on a screen via a projector lens, and enables an internal speaker or an external speaker connected thereto to play back sound.

(2) Configuration of MFP 10

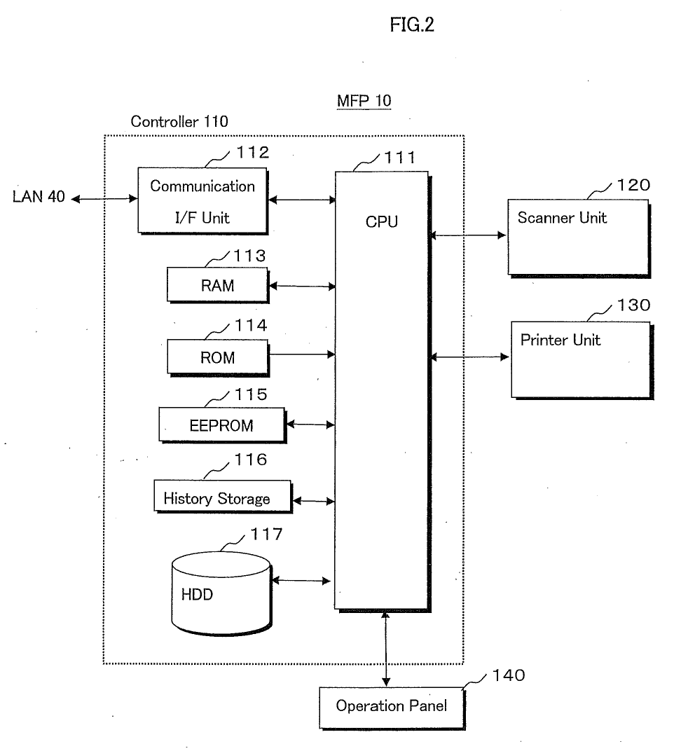

FIG. 2 is a functional block diagram showing the configuration of the MFP 10.

As shown in FIG. 2, the MFP 10 is roughly composed of a controller 110, a scanner unit 120, and a printer unit 130.

The scanner unit 120, which is publicly known, reads an original image using a CCD sensor and generates image data.

The printer unit 130 forms an image on a recording sheet based on image data generated by the scanner unit 120 or image data pertaining to a print job received from the client terminal device 30. The printer unit 130 is realized with a known electrographic printer. However, the printer unit 130 is not limited to this type of the printer.

The operation panel 140 is provided where a user of the MFP 10 can easily operate it. The operation panel 140 has a displaying unit composed of a liquid crystal panel and hard keys, such as numeric keys, start keys and reset keys. The displaying unit displays necessary messages for a user, and a touch panel is layered on the surface of the screen. Touching a given point on the displayed screen, a user can make various entries.

The controller 110 has a CPU 111, a communication I/F (interface) unit 112, a RAM 113, a ROM 114, an EEPROM 115, a history storage 116, and a hard disc storage device (hereinafter, referred to as “HDD”) 117.

The CPU 111 generates digital image signals for reproducing colors of C, M, Y, and K based on obtained image data. The CPU 111 also reads out a necessary program from the ROM 114, comprehensively times and controls the operation of each unit, and smoothly executes the script reading operation and the image forming operation. In addition, the CPU 111 executes a projection job in cooperation with the projector 20 or 21.

The communication interface unit 112 is realized with a LAN card or a LAN board for connecting the CPU 111 and the LAN 40. The communication interface unit 112 receives, via the LAN 40, data of a print job or a projection job transmitted from the client terminal device and transfers the data to the CPU 111. The CPU 111 transfers image data used for projection from the communication interface unit 112 to the projector 20, via the LAN 40.

The RAM 113 is a volatile memory, and is used as a work area while the CPU 111 is executing a program.

The ROM 114 stores therein a program and the like for controlling the operation of each unit in the MFP 10.

The EEPROM 115 stores therein various tables to be described later. The job history storage 116 stores therein a history of a job having been executed. Needless to say, a portion of a storage area in the EEPROM 115 may be used as the job history storage.

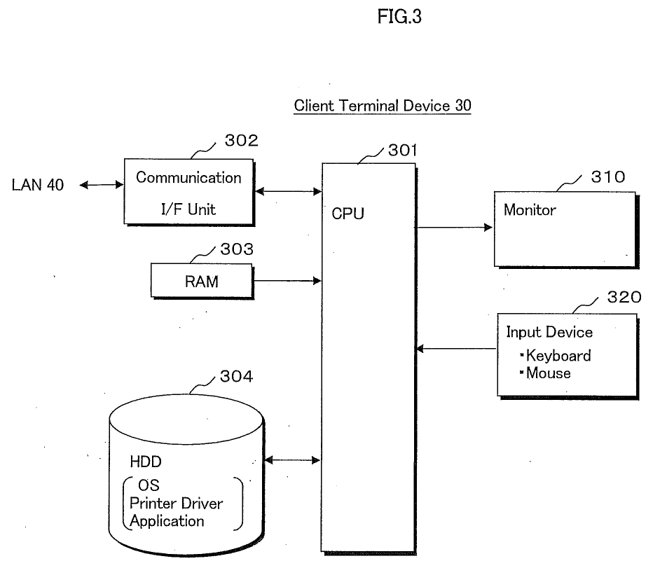

As shown in FIG. 3, the client terminal device 30 is realized with a general-purpose personal computer which has a CPU 301, a communication interface unit 302, a RAM 303, an HDD 304, a monitor 310, and an input device 320, such as a keyboard or a mouse. The computer has the OS, applications for creating images and documents, a printer driver and the like installed therein.

When the printer driver is activated in the client terminal device 30, the client terminal device can issue a regular print job as well as a job for transferring image data from the MFP 10 to the projector 20 and projects an image based on the image data on a screen (“projection job”).

(3) Job Issuing Process by Client Terminal Device 30

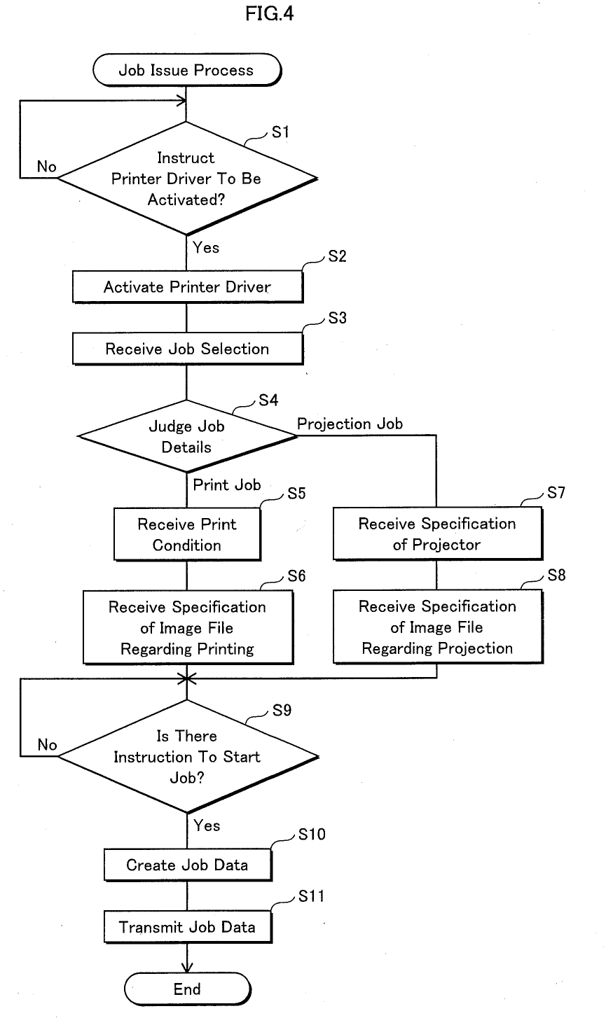

FIG. 4 is a flow chart showing the details of a process for issuing jobs to the MFP 10. The process is executed in response to activation of the printer driver by the CPU 301 of the client terminal device 30.

When receiving an instruction to activate the printer driver from a user via the input device 320 (Step S1: YES), the CPU 301 reads out the program of the printer driver from the HDD 304 and activates the program (Step S2).

After the activation, the monitor 310 displays a job selection screen, a user selects a job from the screen using the input device 320, and the controller 110 receives the selected job (Step S3).

In Step S4, the controller 110 judges a type of the selected job. When the selected job is a print job, the controller 110 receives a print condition (Step S5), and subsequently, receives a specified image file whose image to be printed (Step S6).

When a user gives an instruction to start the print job (Step S9: YES), image data of the specified image file is read from the HDD 304. Job data for the print job is created by adding a header including control information, such as an IP address of the MFP 10, a command to print an image based on the image data, and information for the print condition set as above, to the image data (Step S10). The job data is transmitted to the MFP 10 via the communication interface 302 (Step S11).

In creating the print job data, the image data is converted into a format that can be outputted by a destined MFP 10 (e.g. page description language such as PostScript™).

On the other hand, when judging in Step S4 that the projection job is selected, next the controller 110 receives specification of a projector that is to perform the projection job (Step S7), and receives a specification of an image file whose image to be projected (Step S8).

Subsequently, the controller 110 waits for the instruction to start is given (Step S9: YES), data of the specified image file is read out from the HDD 304. Job data for a projection job is created by adding, to the image data, a header including control information, such as an IP address of the MFP 10, a command to execute the projection job (Step S10), the job data is transmitted to the MFP 10 via the communication interface 302 (Step S11). Thus, the job issuing process is completed.

An image file for the projection job includes video data composed of moving image data and audio data in addition to a bitmap data file for a still image. If image data is in a format not supported by the projector for displaying an image, when projection job data is created, the image data is converted to data supported by the projector. For example, when the specified file is made of text data, the data is converted to bitmap data.

FIG. 5 shows a printer job setting screen 311 that is displayed on the monitor 310 when the printer driver is activated in Step S2.

In this example, a setting screen for the printer job is preferentially displayed as a default. Unless the projection job selection tab 3112 is selected, it is deemed that the print job is specified in Steps S3 and S4 in FIG. 4.

In this setting screen, when a user wants to change a paper size, a magnification, a density, and a copy number, s/he moves a cursor K to the corresponding button and clicks it (hereinafter, simply referred to as “click”, and note that the illustration of the cursor on the setting screen of the monitor 310 is omitted). Accordingly, a print condition that the user desires is set.

In addition, the name of the specified image file is displayed in a file name display field 3113.

Subsequently, click on a start button 3114 creates print job data, and the print job data is transferred to an IP address of the MFP 10 that has been registered as a regular printer in the client terminal device 30 (issuance of the print job).

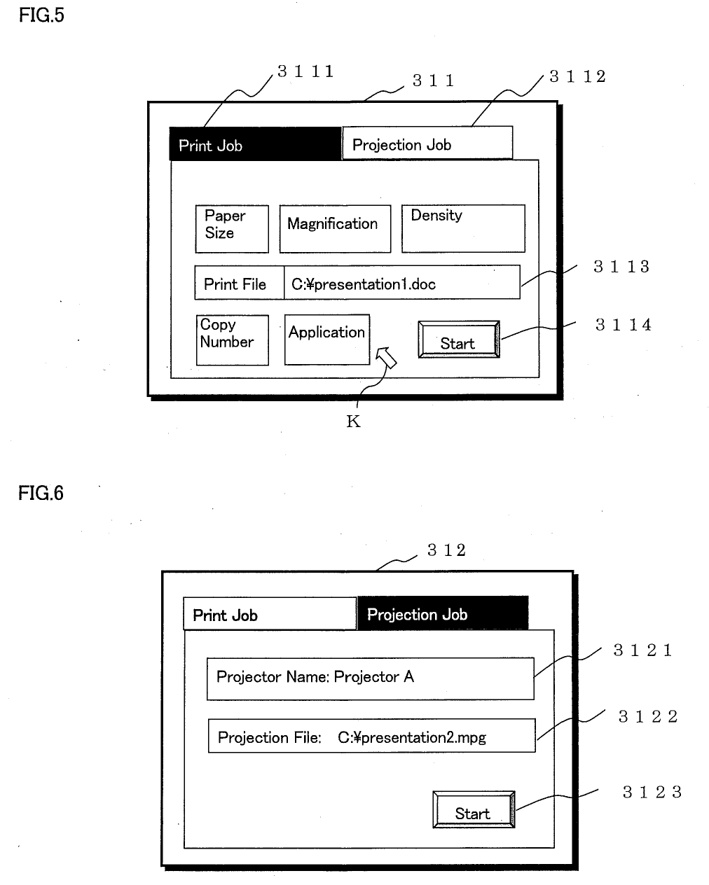

On the other hand, in the setting screen in FIG. 5, when the projection job selection tab 3112 is clicked, a projection job setting screen 312 as shown in FIG. 6 is displayed on the monitor 310, and a projector name inputted via the input device 320 and an image file name of an image to be projected are respectively displayed in a projector name displaying field 3121 and a projection file displaying field 3122.

In response to the click on the start button 3123, projection job data is created and transmitted to the MFP 10. When a projector that is to execute the projection job is specified, the IP address thereof may be inputted instead of a name of the projector.

Note that when the client terminal device 30 can use a plurality of MFPs connected to the LAN 40, the client terminal device 30 programmed as follows is convenient. The IP addresses of the MFPs having been registered in the client terminal device 30. On the setting screens shown in FIGS. 5 and 6, a list of printers corresponding to the MFPs is displayed, and a user can click and select a desirable one of the MFPs. Job data of the print job or the projection job is transmitted to the selected MFP.

(4) Job Execution Process by MFP 10

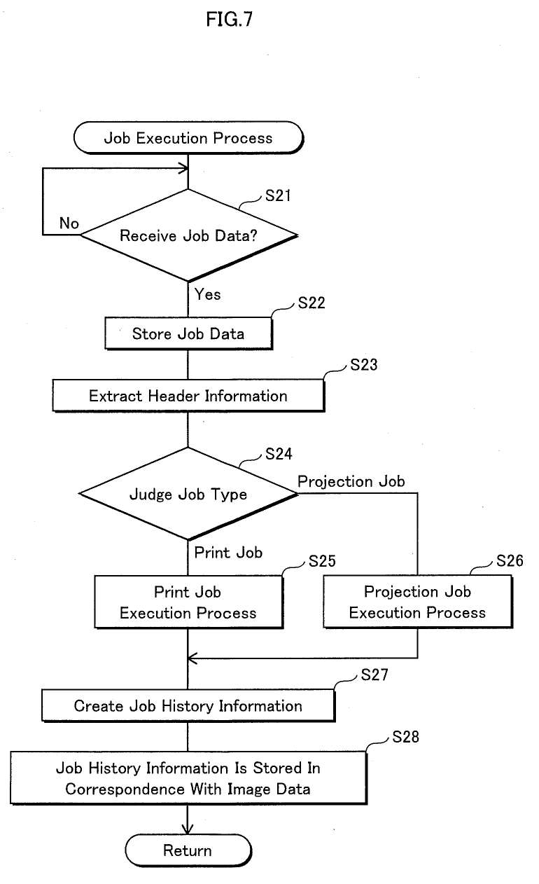

FIG. 7 is a flow chart showing the details of job execution process executed by the controller 110 of the MFP 10. The job execution process is executed as a sub-routine of an unillustrated main flow chart for controlling the operation of the entire MFP 10 (hereinafter, simply referred to as “main flow chart”).

Note that the actual MFP 10 is multifunctional as described above. In addition to the print job and the projection job, the MFP 10 can execute various jobs, such as a copy job for reading an image of an original and creating a copy of an original image and a scan job for reading out an original image and transferring the image to another specified terminal device. In the following flow chart, however, for the simplification, the description is made only of the control of the execution process of the print job and the projection job received from the client terminal device 30.

In the flow chart in FIG. 7, first, the controller 110 judges whether job data is received from the client terminal device 30 (Step S21). Upon reception of the job data, the controller 110 stores the job data in the HDD 117, and the header information is extracted (Step S21: YES, Steps S22 and S23).

The CPU 111 analyzes the above header information, and judges whether the received job data is the print job or the projection job (Step S24).

When the CPU 111 judges in Step S24 that the received job data is the print job, the print job is executed based on the image data under the print condition specified by the user (Step S25). That is to say, when the image data pertaining to the print job has been formatted using the PostScript, the image data is expanded into bitmap data for each page, and the print operation in the printer unit 130 is executed based on the bitmap data.

If the received data is the projection job, the controller 110 establishes the communication by accessing a specified projector. The image data pertaining to the projection job is transferred, and the projection job execution process is executed (Step S26).

Subsequently, the controller 110 creates job history information with regard to the executed job (Step S27), and stores the job history information associating the executed job and its corresponding image data in the job history table (Step S28).

Thus, the job execution process is completed, and the process returns to the main flow chart.

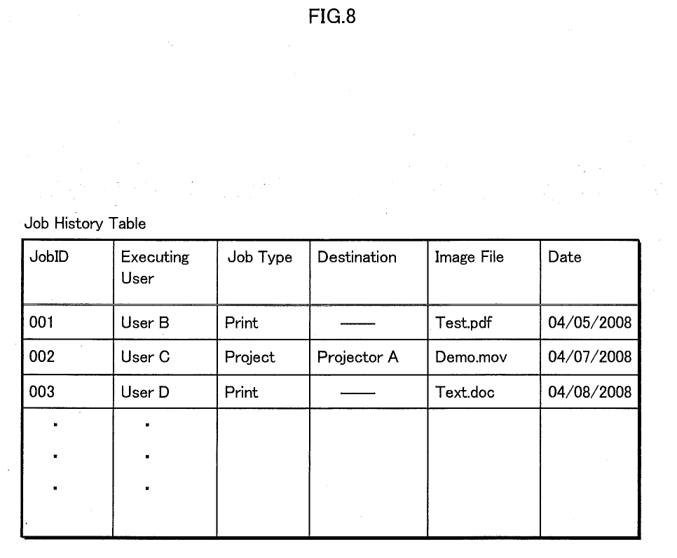

FIG. 8 shows an example of a job history table created in the above-mentioned Step S27.

As shown in FIG. 8, in this table, job history information is stored in association with a name of an image file in the HDD 117. The job history information includes job IDs, information of users who execute the jobs (job issuer), and types of the jobs. For a projection job, the job history information further includes a name of destination projector and job execution date and time. Job IDs are mechanically assigned to jobs such that the jobs are registered as identifiers of the jobs having been executed. However, the names of the image files may be used as the identifiers, instead of the Job IDs.

In this embodiment, jobs having been executed in the past can be executed again with reference to this job history table.

(5) Job Re-Execution Process

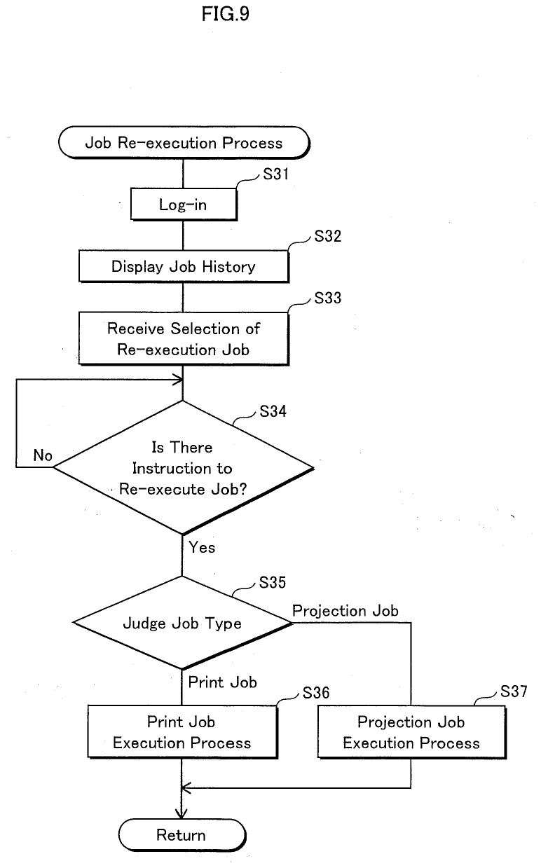

FIG. 9 is a flow chart showing the details of a job re-execution process executed by the MFP 10.

First, a user enters his user ID and password with an operation panel 140 and logs in (Step S31).

In the user management table (unillustrated) in the EEPROM 115 (FIG. 2) of the controller 110, user IDs and their corresponding passwords having been registered by an administrator of the MFP 10. When the user ID and password entered by the user match any of the user IDs and their corresponding passwords registered in the table, use of the MFP 10 is permitted. Needless to say, a user may be permitted to log in only with a user ID unless the security is emphasized.

After the log-in, receiving a given operation from the operation panel 140, the displaying part of the operation panel 140 displays a job history screen (Step S32).

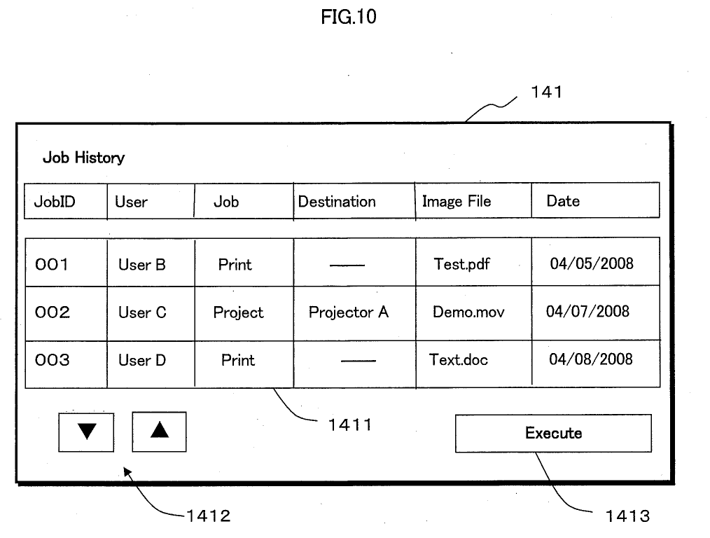

For example, the initial screen (unillustrated) of the operation panel 140 includes a selection tab for re-executing a job. Touching this tab causes a liquid crystal panel of the operation panel 140 to display a job history list screen 141 as shown in FIG. 10.

Here, a job list is scrolled in response to an operation of a scroll button 1412. Touching a target job ID causes the job selection to be received (FIG. 9, Step S33). Subsequently, an instruction to re-execute the selected job is given when the execution button 1413 (FIG. 10) is touched.

Receiving the instruction of the re-execution of the job, the CPU 111 judges a type of the job (FIG. 9, Step S34: YES, Step S35), when the job is the print job, reads image data corresponding to the print job from the HDD 117, and executes the print job based on this image data (Step S35: print job, Step S36). When the job is the projection job, the CPU 111 reads image data corresponding to the projection job and transmits it to the projector 20 (Step S35: projection job, Step S37).

In this embodiment, the projection job is transmitted to the projector registered in the job history table. Note that the present invention is not limited to the above embodiment. It may be programmed that a user selects a new projector used for the projection.

Thus, a history of a job that has been executed once is stored in association with its image data, and at a later date, the job can be selected and re-executed. This is user-friendly, because a user is not bothered to activate a printer driver again with the client terminal device 30, search for a desired file, nor issue again the job to the MFP 10.

Jobs and their corresponding image data registered in the job history table may be deleted in response to a user operation. Alternatively, oldest one of the jobs may be automatically deleted when the storage capacity of the HDD 117 is equal to or lower than a predetermined value.

<Modification of Control in Job Execution Process and the Like>

Although the present invention is described according to the embodiment, needless to say, the present invention is not limited to the above embodiment. In particular, implementation of the job execution process by the MFP 10 and a modification of the printer driver to be installed in the client terminal device 30 as provided below can further enhance the convenience.

(1) In the job execution process pertaining to the above embodiment (FIG. 7), after processing the received job, the reception of the subsequent job is waited. However, actually; it often occurs that the controller 110 receives a plurality of jobs in a short period of time. As a consequence, the jobs contend with one another.

In such a situation, in order to manage contending jobs to be executed in the order in which they are received, the controller 110 does not execute a projection job until the controller 110 has completely executed other jobs that had been received earlier than the projection job.

However, it can be assumed that when a projection job is issued, the projection job needs to be executed immediately, for example, during a meeting or a presentation, as described above. When jobs are managed in the order they are received as described above, latency of each projection job is prolonged, which causes great inconvenience to a user.

To solve the above problem, this modification aims to preferentially execute the projection job when a plurality of jobs contend with one another.

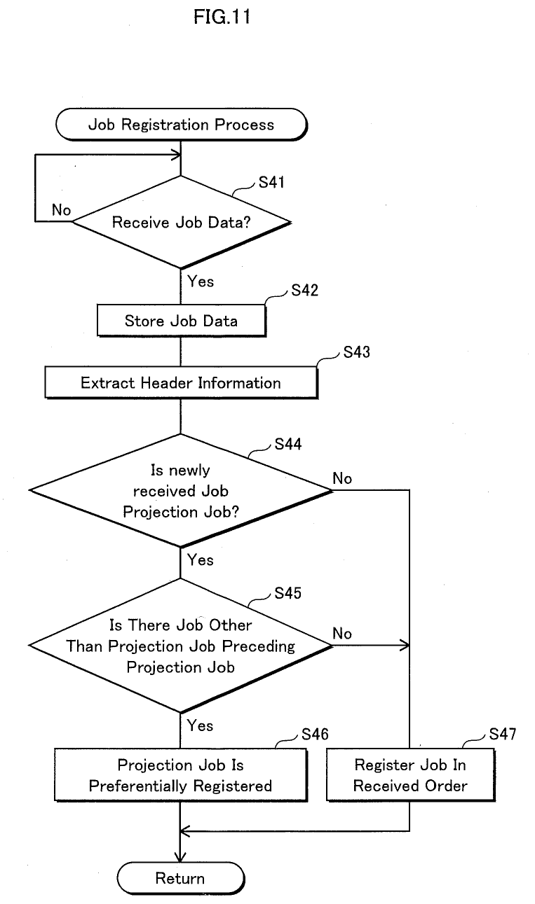

FIG. 11 is a flow chart showing the details of the control of the controller 110 in the job register process pertaining to this modification. Note that, in this example, execution of the register process of the history job is omitted (Steps S27 and S28 in FIG. 7) for simplification of the description.

First, the CPU 111 judges whether it receives job data (Step S41). When judging affirmatively, the controller 110 stores this job data in the HDD 117 (Step S41: YES, Step S42), and extracts the header information (Step S43). The CPU 111 judges whether a type of the newly received job is the projection job based on the header information (Step S44).

When the CPU 111 judges the newly received job is the projection job (Step S44: YES), subsequently, the CPU 111 judges whether unexecuted jobs other than the projection job have been registered preferentially over the projection job (Step S45).

If unexecuted jobs that have been registered has priority over the projection job (Step S45: YES), the CPU 111 changes the priority of the projection job to be registered preferentially over these unexecuted jobs (Step S46).

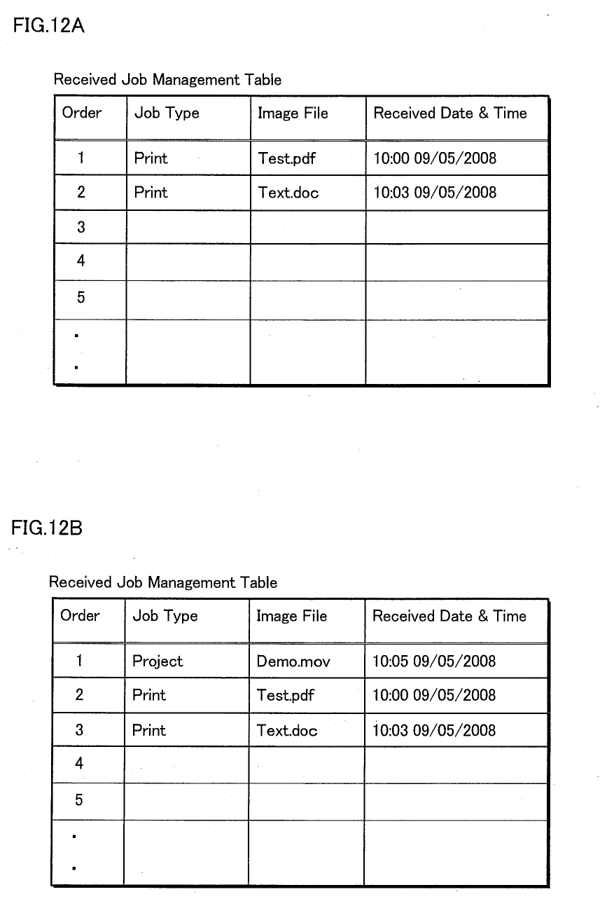

FIGS. 12A and 12B each show an example of a received job management table for registering the received jobs. This received job management table is stored in the EEPROM 115, for example.

In this example, as shown in FIG. 12A, two unexecuted print jobs have been initially registered in the received job management table. When a new projection job is received in this situation, as shown in FIG. 12B, the new projection job has the priority over the unexecuted print jobs (in this example, first priority), the priority of each unexecuted print jobs is decremented by one.

Based on FIG. 11, when the CPU 111 judges in Step S44 that the newly received job is not the projection job (Step S44: NO), or when the CPU 111 judges in Step S45 that there are no jobs that has the priority over the projection job (Step S45: NO), the newly received job is directly registered at the end of the received job management table (Step S47), and subsequently, the process returns to the main flow chart.

When executing jobs, the controller 110 refers to the received job management table, and manages the jobs such that one highest priority is executed. The controller 110 deletes the executed job from the received job management table, and the priority of each of the remaining jobs is increased by one.

Thus, whenever a projection job is received, it can always be preferentially executed over the other jobs so that a meetings or a presentation can be effectively conducted.

(2) In addition, the MFP 10 may have a consecutive playback mode by which another projection job is executed continually from the projection job in execution.

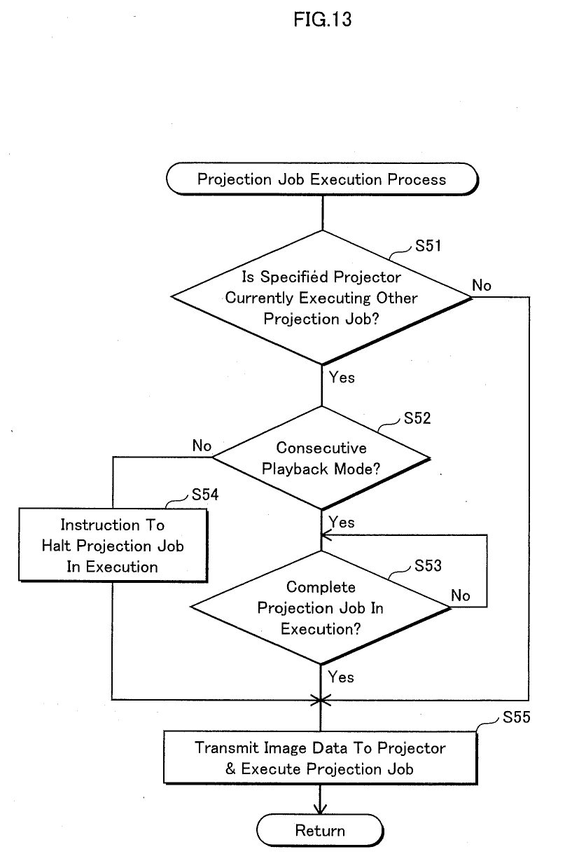

FIG. 13 is a flow chart showing the details of the control of the projection job execution process in which process with regard to the consecutive playback mode is executed by the controller 110 of the MFP 10. This projection job execution process is executed as a sub-routine of Step S26 in FIG. 7.

In executing the projection job, the CPU 111 initially judges whether a projector specified by a user (it is assumed that the projector 20 is specified) is currently executing another projection job (Step S51).

When the projection job in execution pertains to projection with regard to the image data that is being transmitted from the controller 110, the controller 110 can judge that the projector 20 is currently executing the projection job. In addition, the controller 110 can make the judgment by accessing the projector 20 to obtain a reply showing that the other projection job is currently being executed.

When the CPU 111 judges in Step S51 that the specified projector is not currently executing other projection jobs (Step S51: NO), image data pertaining to the projection job is immediately transmitted to the projector 20 (Step S55).

However, when the CPU 111 judges that the specified projector 20 is currently executing the other projection job (Step S51: YES), the CPU 111 judges whether “consecutive playback mode” has been set for the received projection job (Step S52).

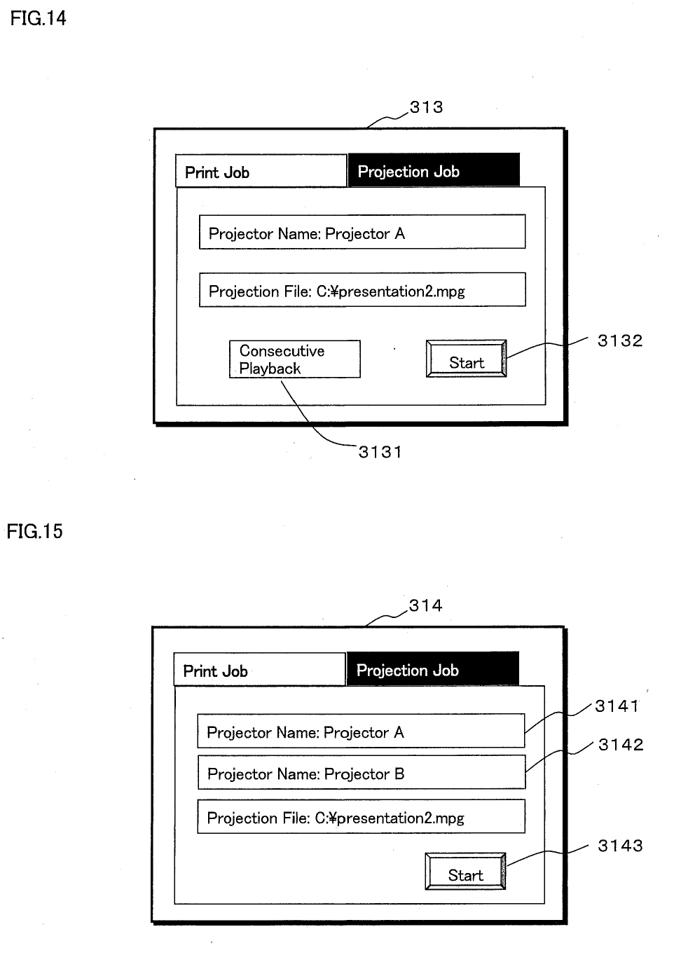

FIG. 14 shows an example of a setting screen 313 for the projection job in the printer driver of the client terminal device 30. When a consecutive playback button 3131 shown in FIG. 14 is pushed, and when a start button 3132 is pushed, an instruction to execute the projection job in the consecutive playback mode is added to the header information, and the instruction is issued to the MFP 10.

The controller 110 makes the judgment in Step S52 in FIG. 13 according to whether there is an instruction of the “consecutive playback mode” in the header information of the received projection job data.

In a case where the consecutive playback mode has been set, image data is transmitted to the projector 20 after the completion of the other projection job in execution, (Step S53: YES, Step S55), and images based on the image data are consecutively played back by the projector 20.

Thus, images can be consecutively presented to attendees of a meeting or a presentation, which facilitates the proceeding of the meeting and the like.

Note that the CPU 111 can judges the completion of the other projection job in execution in Step S53, for example, by accessing the projector 20 to obtain the status information thereof in an extremely short cycle (e.g. 0.5 second).

On the other hand, when the CPU 111 judges in Step S52 that the consecutive playback mode has not been set (Step S52: NO), the CPU 111 gives an instruction to halt the projection job in execution to the projector 20 (Step S54). Subsequently, the controller 110 transmits image data pertaining to the received projection job to the projector 20 to execute the projection job (Step S55), and the process returns to the main flow chart.

This consecutive playback mode is useful to play back the received projection job consecutively from the other projection job in execution.

(3) A plurality of projectors may execute one projection job issued from the client terminal device 30. As a consequence, for example, projectors each provided in a different meeting place can project the same video image, which provides convenience.

FIG. 15 shows an example of the projection job setting screen 314 in the printer driver of the client terminal device 30 in such a case. In this example, two projectors can be specified, and names of the two specified projectors are respectively displayed in name display fields 3141 and 3142. Click on a start button 3143 prompts the names of the two projectors to be added to the header information, and the projection job is issued to the MFP 10.

The MFP 10 receives the projection job data, and transmits image data to the two projectors specified by multicasting.

(4) According to the above embodiment, when a user specifies a projector for projection, the device name or the IP address of the projector is inputted in the setting screen for the projection job in the printer driver (see FIG. 6).

When one or two projectors are connected to the MFP 10, and when presentation is always made in the same meeting place, projectors having been inputted may be registered by the client terminal device 30. However, when a large number of projectors are connected to the network, or presentation is made at a different meeting place, a user has to input the projector every time necessary, which is bothering and inefficient.

To solve the above problem, this modification enables projectors connected to the network to be searched and listed. A user can select a desired projector from among the listed projectors, which saves a user from specifying a projector.

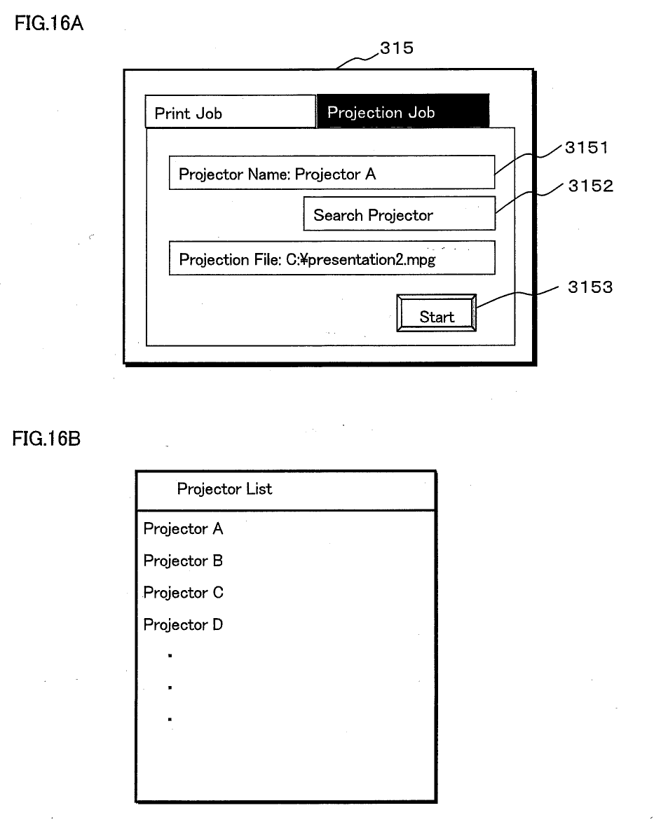

FIG. 16A shows a projection job setting screen 315 that is displayed on the monitor 310 of the client terminal device 30 in accordance with this modification.

As shown in FIG. 16A, the name of a default projector (projector A in this modification) is displayed on a display projector name display field 3151. Pushing a projector search button 3152 starts a projector search process.

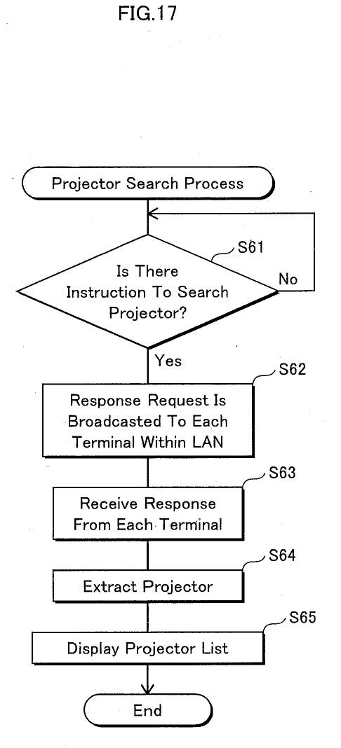

FIG. 17 is a flow chart showing the details of the projector search process executed by the client terminal device 30.

Initially, the client terminal device 30 judges whether it receives an instruction for searching a projector (Step S61). If the judgment is affirmative (Step S61: YES), the client terminal device 30 transmits a response request to other terminal device connected to the LAN 40 by broadcasting (Step S62).

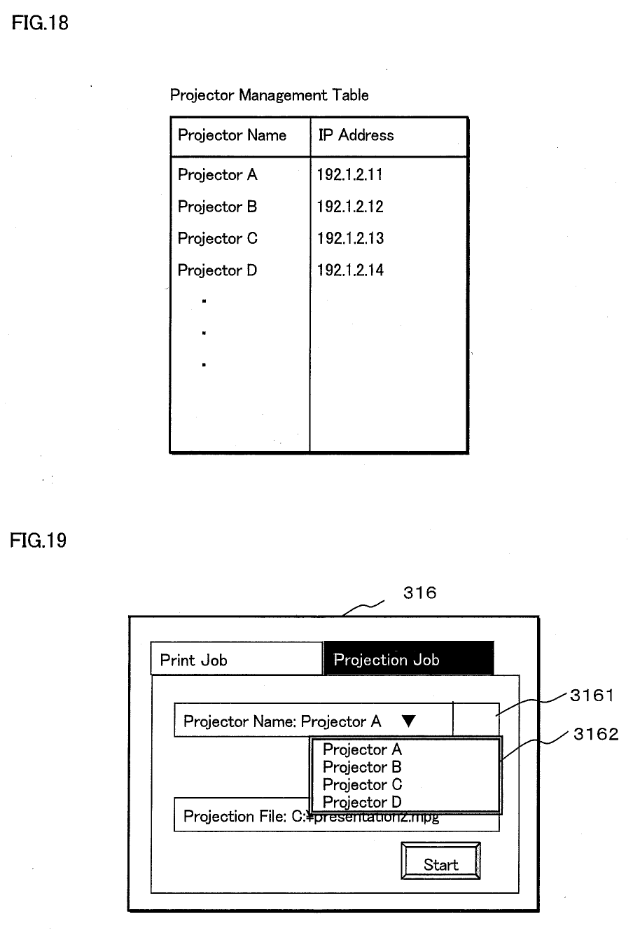

In response to the response request, each of other terminal devices transmits a response showing its device name and IP address to the client terminal device 30. Receiving the response (Step S63), the client terminal device 30 extracts only information on a projector from the response (Step S64). The client terminal device 30A creates projector management table as shown in FIG. 18, for example, and stores the projector name and the IP address in correspondence with each other in the HDD 304. In addition, a projector list listing thereon only the projector names as shown in FIG. 16B is displayed on the screen of the monitor 310 (Step S65). Thus, this projector search process is completed.

When a user clicks a desired projector on the projector list, the name of the desired projector is displayed in a projector entry field 3151. Thus, a user can specify the projector.

(5) As a method for facilitating the specification of a projector, the MFP 10 may obtain information showing available projectors.

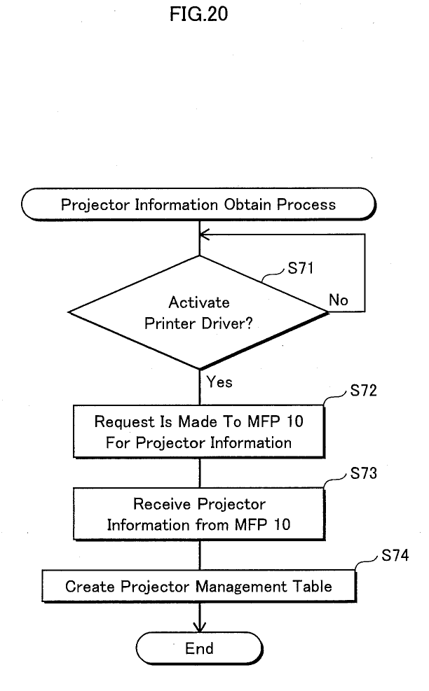

That is to say, as shown in a flow chart of a projector information obtain process in FIG. 20, when the client terminal device 30 activates the printer driver (Step S71: YES), the client terminal device 30 makes a request to the MFP 10 for information relating to the projectors registered in the MFP 10 (Step S72).

Content similar to that shown in FIG. 18 has been created by a user or an administrator of the MFP 10 and is stored in the EEPROM 115 of the MFP 10 as projector information. Receiving the above request, the MFP 10 transmits the projector information to the client terminal device 30.

Receiving the projector information, the client terminal device 30 creates a projector management table in the HDD 304 based on this projector information (Step S74). Thus, the projector information obtain process is completed.

When a pull-down button 3161 is clicked on the projection job setting screen 316 shown in FIG. 19, a list 3162 of the projector names in the projector management table is displayed on a pull-down menu. A user specifies a projector by clicking a desired projector on the list 3162.

Since the MFP 10 is relatively large, other devices placed at a meeting place are usually used instead of the MFP 10. Image data and other materials necessary for a meeting and the like are stored in a laptop, and the project information is downloaded from the MFP 10 to the laptop at a presentation place, which facilitates the specification of a projector, and thus is convenient.

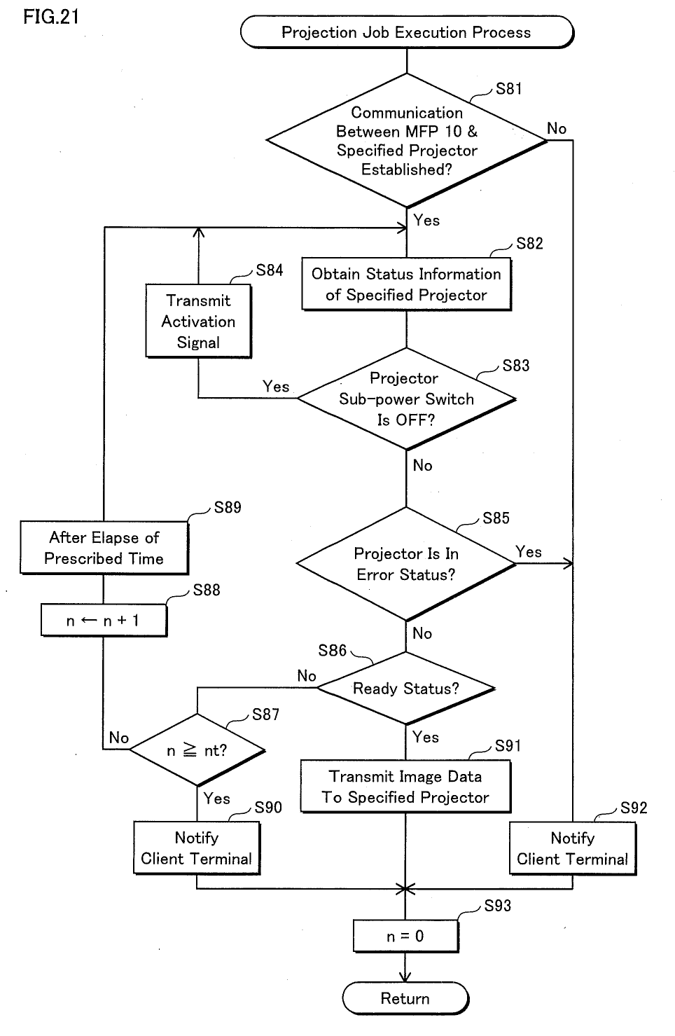

(6) When image data is transmitted from the MFP 10 to the projector 20 in order to execute the projection job, there is a case where the projector 20 is not necessarily ready for display. FIG. 21 is a flow chart showing a modification of the projection job execution process executed by the controller 110 of the MFP 10. The projection job execution process is executed as a sub-routine of Step S26 of FIG. 7.

Note that, in this example, the projector 20 has a main power switch and a sub-power switch. Unless the main power switch is turned OFF, power distribution to a communication controller is not stopped. By turning ON the sub-power switch, a projection lamp is lighted, which supplies electrical power to other necessary controllers to make them operable (ready status). The communication controller is programmed to successively update information (status information) showing the status of the projector 20 and is stored in a nonvolatile memory in the communication controller in correspondence with its IP address and its device name. The status information includes information regarding ON/OFF status of the sub-power switch, error status, ready status and the like.

Initially, the MFP 10 accesses a specified projector (hereinafter, the specified projector corresponds to the projector 20), and the CPU 111 judges whether communication between the MFP 10 and the projector 20 has been established (Step S81).

When the main power switch of the projector 20 is OFF, or when the network is disconnected due to some trouble, the communication cannot be established (Step S81: NO), then the controller 110 notifies status information showing such disconnection of the client terminal device 30 that has issued the projection job (Step S92).

Receiving this notification, the client terminal device 30 has this disconnection status displayed on the monitor 310.

On the other hand, when the communication between the MFP 10 and the projector 20 can be established (Step S81: YES), the controller 110 requests the projector 20 to transmit the status information, and obtains the status information from the projector 20 (Step S82).

Based on this status information, the CPU 111 initially judges whether the power switch (sub-power switch) of the projector 20 is OFF (Step S83). If the judgment is affirmative, the controller 110 transmits an activation signal to the projector 20 (Step S83: YES, Step S84), and instructs to turn ON the sub-power switch of the projector 20. Then, the CPU 111 obtains the status information again (Step S82).

When the CPU 111 judges in Step S83 that the sub-power switch of the projector 20 is ON (Step S83: NO), subsequently, the CPU 111 judges whether the projector 20 is in the error status (Step S85).

The “error status” occurs when the lamp is not righted due to the exhaustion of the lamp life or a trouble of a driving structure for focusing the projection lens and the like.

If the projector 20 is not in the error status (Step S85: NO), subsequently the CPU 111 judges whether the projector 20 is in the ready status (Step S86).

When the projector 20 is not in the ready status (Step S86: NO), the CPU 111 judges whether a variable n, which is the number of obtaining the status information, is equal to or larger than a predetermined maximum number nt (e.g. 5 times) (Step S87). When the variable n is smaller than the maximum number nt (Step S87: NO), the CPU 111 increments the variable n by 1 (Step S88), and after an elapse of predetermined time (e.g. 5 seconds) (Step S89), the CPU 111 obtains the status information of the projector 20 again (Step S82). A value of the variable n is temporarily retained in the RAM 113, for example.

When the projector 20 does not come to be in the ready status even if this status information obtain operation is repeated for nt times, (Step S86: NO, Step S87: YES), it is deemed, after all, that the projector 20 is in the error status, and such status information is notified to the client terminal device 30 (Step S90).

When the CPU 111 judges in Step S86 that the projector 20 is in the ready status (Step S86: YES), after the transmission of image data to the projector 20 (Step S91), the CPU 111 resets the variable n to “0” (Step S93).

After the completion of the above process, the process returns to the flow chart in FIG. 7.

(7) According to the above embodiment, the printer driver of the client terminal device 30 selects one of the print job and the projection job and issues the selected one to the MFP 10. However, the printer driver may select both of the jobs and issue them simultaneously.

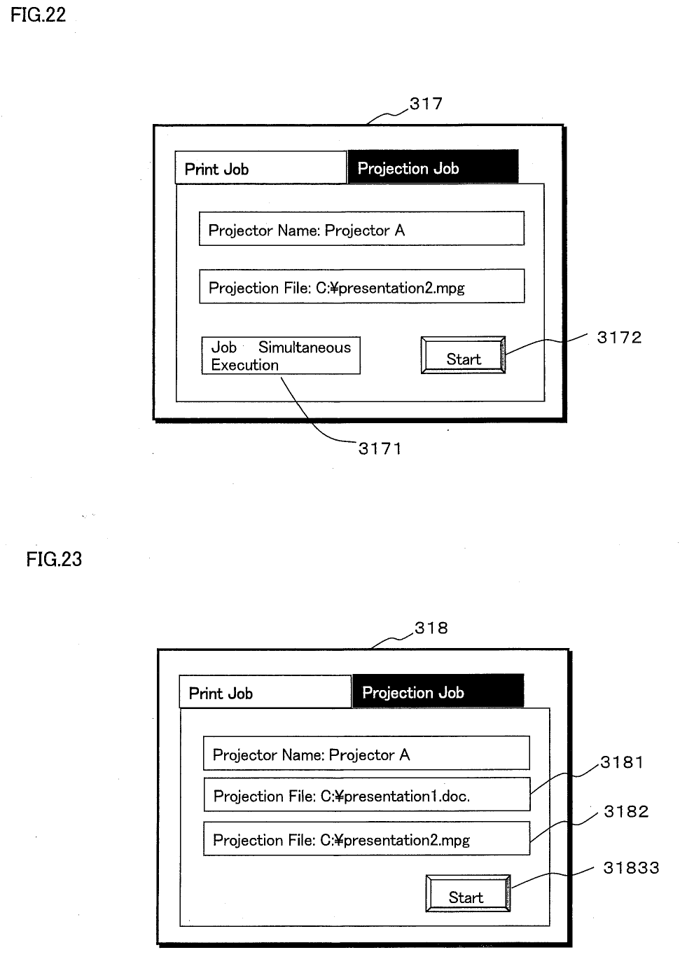

For example, after the print condition has been set in the print job setting screen 311 in FIG. 5, a user may click the projection job tab 3112 to switch from the print job setting screen 311 to the projection job setting screen 317 as shown in FIG. 22. After the specification of a projector and image data to be used for the projection, click on a job simultaneous execution button 3171 causes the projection job to be issued to the MFP 10 subsequently to the print job.

The MFP 10 spools the jobs and sequentially executes them.

With the stated configuration, the print job and the projection job can be issued simultaneously, and necessary images can be displayed and materials associated with the images can be printed out and distributed to attendees, which is very convenient.

Note that when a plurality of MFPs similar to the MFP 10 are connected to the LAN 40, each of the job setting screens of the printer drivers is configured to receive a specified one of the MFPs. Thus, while one MFP is executing the print job, the other MFP may be executing the projection job.

In such a case, the client terminal device 30 may search a plurality of MFPs connected to the LAN 40, according to the projector search process described in the modification (4).

(8) As shown in FIG. 23, the projection job setting screen 318 has two fields 3181 and 3182 for displaying image files to be projected. When one projection job is issued, image data of the two image files may be transmitted, and an instruction is given to the MFP 10 to consecutively perform the projection of the two image files. Furthermore, three or more image files may be specified.

In this case, for example, numbers are assigned to the image files in the order in which they are specified, and information of the total number M of the files is added to the header information, and transmitted to the MFP 10 as projection job data.

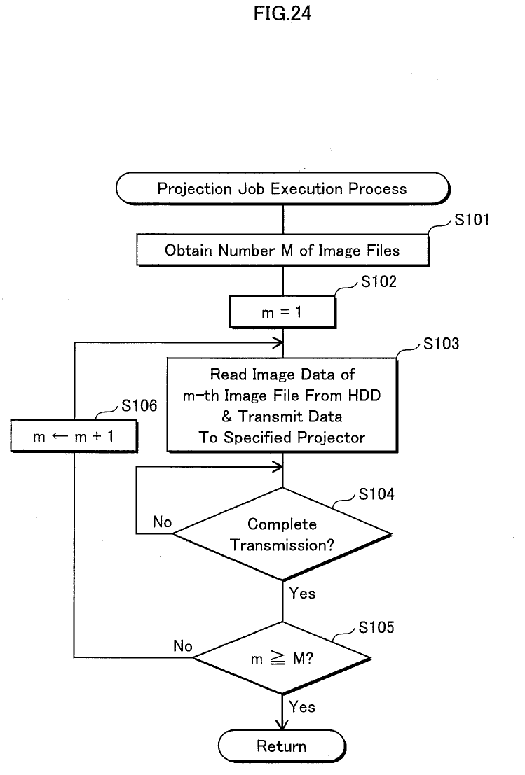

FIG. 24 is a flow chart showing the details in a projection job execution process executed by the controller 110 of the MFP 10 when a projection job specifying a plurality of image files is received. The projection job execution process is executed as a sub-routine of Step S26 in FIG. 7.

Initially, with reference to the header information of the projection job data received and stored in the HDD 117, the CPU 111 obtains the number M of image files for projection (Step S101), and sets a variable m to 1 (Step S102).

Subsequently, the controller 110 reads image data of the m-th image file (here, the first) from the HDD 117, and transmits it to a specified projector (projector 20) (Step S103). After the completion of the transmission (Step S104: YES), the CPU 111 judges whether the variable m comes to be equal to or larger than M (Step S105). If the judgment is negative, the CPU 111 increments the variable m by only 1 (Step S105: NO, Step S106), and transmits the subsequent image file (Step S103).

When the CPU 111 judges in Step S105 that m≧M holds (Step S105: YES), the process returns to the flow chart in FIG. 7, for this indicates that the transmission of all the image files has been completed.

As described above, when one projection job is issued, a plurality of image files are specified. Based on this, images based on image data of the plurality of files are sequentially projected, which is very efficient, saving the jobs from being issued one after another. In addition, since a plurality of projection jobs are identified as one job, a job issued by another user does not interfere with the projection job so that the images based on the image data of a plurality of files are smoothly projected in a consecutive manner.

(9) Note that in a case where the projection job issued by the client terminal device 30 specifies a plurality of projectors, each of the projectors may have different specs, and may have a different resolution of a projectable image data.

Some projectors can automatically convert the resolution of inputted image data to a suitable resolution. However, some inexpensive projectors cannot change the resolution, or if they can, the resolution converting process requires substantial time.

To solve the above problem, the MFP 10 transmits image data after converting in advance the image data at a resolution suitable for the destination projector. Thus, an image can be projected at a resolution optimal for each type of projectors.

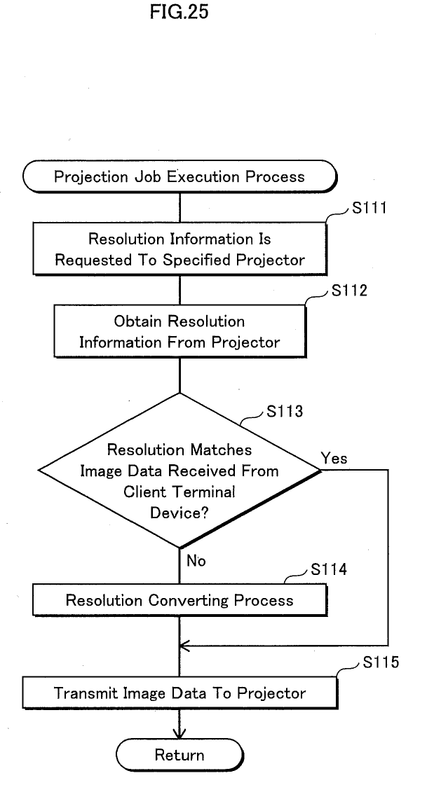

FIG. 25 is a flow chart showing the details in a projection job execution process pertaining to this modification, and this process is executed as a sub-routine of Step S26 in FIG. 7.

Initially, the controller 110 establishes the communication between the MFP 10 and the projector (projector 20) specified by a user, and requests information relating to the resolution of the projector (resolution information) (Step S111).

Note that the resolution information has been stored, as a default, in a nonvolatile memory, such as a ROM and an EEPROM inside the controller, at a production stage of the projector 20.

The controller 110 receives and obtains the resolution information transmitted from the projector 20 (Step S112). The CPU 111 judges whether this resolution matches the resolution of image data pertaining to the projection job received by the client terminal device 30 (Step S113).

If both the resolutions do not match each other, the controller 110 converts the resolution of image data pertaining to the projection job to the resolution suitable for the projector (Step S113; NO, Step S114). For example, to lower the resolution, the controller 110 performs compression process to reduce the number of pixels, and to increase the resolution, data between the pixels is interpolated to increase the number of the pixels. Since a known method is used to change the resolution, details of the resolution convert process are not described here.

After the resolution is changed, the controller 110 transmits image data to the projector 20 (Step S115), and the process returns to the flow chart in FIG. 7.

When it is judged “YES” in Step S113, controller 110 does not change the resolution of image data, and may transmit the unchanged resolution to the projector 20. The process returns to the flow chart in FIG. 7.

(10) In the modification (9), the MFP 10 executes the resolution convert process. However, after changing the resolution, the printer driver of the client terminal device 30 that issues the job may transmit the changed resolution to the MFP 10.

That is to say, when a projector is specified and an image file to be projected is selected in a projection job setting screen, the CPU 301 of the client terminal device 30 accesses the specified projector, and obtains resolution information of the specified projector. When the resolution of the selected image file is different from the resolution of the specified projector, after changing the resolution of image data of the file, the CPU 301 of the client terminal device 30 adds necessary header information the changed resolution and transmits to the MFP 10 as projection job data.

Since the details of control in this case are similar to that of the flowchart in FIG. 25, such a flow chart is not illustrated in particular. The differences therebetween are as follows. The entity that executes Steps S111-S114 is not the controller 110 of the MFP 10 but the CPU 301 of the client terminal device 30. In addition, the details of Step S115 in FIG. 25 are changed to “the projection job is issued from the client terminal device 30 to the MFP 10”.

The above embodiments and modifications may be combined in as many patterns as possible.

For example, when the client terminal device 30 searches projectors on the network using broadcasting, the client terminal device 30 obtains resolution information of the projector and registers in the projector management table in the modification (4). Thus, it is unnecessary to refer to the projector for the resolution information each time the projection job is issued in the modification (9).

<Other>

(1) Each control program in accordance with the above embodiment and modification can be recorded onto various types of a computer readable recording medium including a magnetic tape, a magnetic disc such as a flexible disk, an optical recording medium such as DVD, CD-ROM, CD-R, MO, and PD, a flash memory recording medium such as Smart Media™, COMPACTFLASH™. Each control program may be produced, transferred or the like in the form of such a recording medium, or transmitted or supplied via various types of a wired or wireless networks including the internet, broadcasting, electric communication line, satellite communication or the like.

In addition, the program for realizing the present invention does not need to include all the modules for causing the computer to execute the above-mentioned processes. With use of various types of general-purpose, programs that can be additionally installed in the information processing device, such as a program included in a communication program or an operating system (OS), a computer may execute each process of the present invention.

(2) The configuration of the image displaying system does not need to be limited to the above embodiments.

At least one for each of the MFP, the projector, and the client terminal device is sufficient for the minimum configuration to realize the present invention. Any number of the MFPs, the projectors and the client terminal devices may be connected with one another as long as there is at least one for each of them.

Each device may be connected not only via a LAN but also via a WAN (Wide Area Network) or the Internet. In such a case, the same image can be simultaneously displayed at a plurality of remote venues, which is very convenient.

(3) In the above embodiment, a liquid crystal projector is taken as en example of the image displaying device. However, the present invention does not need to be realized with a liquid-crystal type display. For example, instead of the liquid crystal panel, a DLP (digital light processing) projector using a DMD (digital micromirror device) is also applicable.

In addition, in recent years, a large liquid-crystal monitor or a large plasma display have appeared. Particularly in a small meeting place, they may be used instead of a projector. In such a case, they are not connected to a LAN, and output terminals of video and audio of the MFP are often connected directly to the input terminals of the liquid-crystal monitor and the plasma display.

(4) The description is given of the MFP that is a complex machine as an example of the image forming apparatus. However, in some cases, the image forming apparatus may be a device specialized device in copying or a printing that is connectable to the network.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image displaying system including a terminal device, an image forming apparatus and an image displaying apparatus,
the terminal device comprising:
a job issuer operable to issue at least one of an image forming job and an image displaying job to the image forming apparatus, and
the image forming apparatus comprising:
a job receiver operable to receive a job issued by the terminal device;
an analyzer operable to conduct an analysis of the job received by the job receiver;
an image forming unit operable, when the analysis shows that the received job is an image forming job, to form an image according to image data pertaining to the image forming job; and
an image data transferrer operable, when the analysis shows that the received job is an image displaying job, to transfer image data pertaining to the image displaying job to the image displaying apparatus, wherein
the image displaying apparatus displays an image according to the image data transferred from the image forming apparatus.

2. The image displaying system of claim 1, wherein
the job issuer simultaneously issues an image forming job and an image displaying job.

3. An image forming apparatus connectable to a terminal device and an image displaying apparatus, the image forming apparatus comprising:
a job receiver operable to receive a job issued by the terminal device;
an analyzer operable to conduct an analysis of the job received by the job receiver;
an image forming unit operable, when the analysis shows that the received job is an image forming job, to form an image according to image data pertaining to the image forming job; and
an image data transferrer operable, when the analysis shows that the received job is an image displaying job, to transfer image data pertaining to the image displaying job to the image displaying apparatus.

4. The image forming apparatus of claim 3 further comprising:
a job register operable to register therein the job received by the job receiver; and
a job execution order determiner operable to determine an execution order of the registered job, wherein
when a new job received by the job receiver is an image displaying job, the job execution order determiner determines an order of the image displaying job so as to be preferentially executed over other registered jobs than an image displaying job.

5. The image forming apparatus of claim 3 further comprising:
a history storage that stores therein an identifier of an image displaying job that has been executed, as a history;
an image data storage that stores therein image data pertaining to the executed image displaying job in association with the identifier; and
a re-execution job receiver operable to receive an identifier specified from the history, wherein
the image data transferrer reads, from the image data storage, image data pertaining to the image displaying job identified by the specified identifier and transfers the read image data to the image displaying apparatus.

6. The image forming apparatus of claim 3 further comprising:
a resolution obtaining unit operable to obtain resolution information showing a resolution of the image displaying apparatus; and
a resolution converter operable to change, according to the resolution information, a resolution of image data to be transferred to the image displaying apparatus, wherein
the image data transferrer transfers the image data whose resolution has been changed, to the image displaying apparatus.

7. The image forming apparatus of claim 3 further comprising:
an execution status obtaining unit operable to obtain execution status information showing an execution status of an image displaying job executed in the image displaying apparatus, wherein
in a case where the job receiver receives, from the terminal device, an image displaying job having an instruction to perform consecutive display, if the image displaying apparatus is currently executing another image displaying job, the image data transferrer transfers image data pertaining to the image displaying job having the instruction when the execution status information shows that the other image displaying job is completed.

8. The image forming apparatus of claim 3 further comprising:
a device status obtaining unit operable to obtain device status information showing a device status of the image displaying apparatus; and
a notifier operable to notify, when the job receiver receives an image displaying job from the terminal device, if the device status information shows that the image displaying apparatus is in a status where the image displaying is unexecutable, the terminal device of the device status information.

9. A job execution control method executed by an image forming apparatus that is connectable to a terminal device and an image displaying apparatus and that includes an image forming unit and an image data transferrer, the job execution control method comprising the steps of:
receiving a job issued by the terminal device;
analyzing the job received by the job receiver;
forming, when the analysis shows that the received job is an image forming job, an image according to image data pertaining to the image forming job; and
transferring, when the analysis shows that the received job is an image displaying job, image data pertaining to the image displaying job to the image displaying apparatus.

10. A computer readable recording medium recording thereon a job execution control program executed by an image forming apparatus that is connectable to a terminal device and an image displaying apparatus and that includes an image forming unit and an image data transferrer, the job execution control program causing a computer in the image forming apparatus to execute the steps of:
receiving a job issued by the terminal device;
analyzing the job received by the job receiver;
forming, when the analysis shows that the received job is an image forming job, an image according to image data pertaining to the image forming job; and
transferring, when the analysis shows that the received job is an image displaying job, image data pertaining to the image displaying job to the image displaying apparatus.

11. A computer readable recording medium recording thereon a printer driver executed by a terminal device included in an image displaying system, the system including the terminal device, an image forming apparatus and at least one image displaying apparatus, the printer driver causes a computer in the terminal device to execute:
a first receiving process of receiving at least one of specification of an image forming job, and specification of an image displaying job;
a second receiving process of receiving specification of image data used for display when the image displaying job is specified;
a third receiving process of receiving specification of an image displaying apparatus that displays an image according to the specified image data; and
a transmitting process of transmitting, to the image forming apparatus, the specified image data to which control information is added, the control information including information for identifying the specified image displaying apparatus and an instruction to display an image according to the specified image data.

12. The computer readable recording medium of claim 11, wherein
the image forming apparatus retains information about at least one image displaying apparatus connected to the image forming apparatus, and
in the third receiving process, the retained information is obtained from the image forming apparatus, an image displaying apparatus that is to display an image according to image data pertaining to the image displaying job is specified from a list of the image displaying apparatus shown in the obtained information, and the specification of the image displaying apparatus is received.

13. The computer readable recording medium of claim 11, wherein
an image displaying apparatus is connected to the image forming apparatus and the terminal device on a network, and
in the third receiving process, the image displaying apparatus on the network is searched, the image displaying apparatus that is to display an image according to the image displaying job is specified from a list of the searched image displaying apparatus, and the specification of the image displaying apparatus is received.

14. The computer readable recording medium of claim 11, wherein
in the second receiving process, specification of image data of a plurality of files is received, and
in the transmitting process, the specified image data of the plurality of files to which control information is added is transmitted to the image forming apparatus, the control information including information for identifying the specified image displaying apparatus and an instruction to perform consecutive display according to the specified image data of the plurality of files.

15. The computer readable recording medium of claim 11, wherein
the image displaying system includes a plurality N of image displaying apparatuses,
in the third receiving process, specification of a number n of the plurality N of image displaying apparatuses is received, n being plural and equal to N or smaller, and
in the transmitting process, the specified image data to which control information is added is transmitted to the image forming apparatus, the control information including information for identifying the specified number n of the image displaying apparatuses and an instruction for each of the n image displaying apparatuses to display an image according to the specified image data.
